(19) United States
(12) Patent Application Publication
(10) Pub. No.: US 2011/0078122 A1
(43) Pub. Date: Mar. 31, 2011

(54) Data set selection mechanism

(75) Inventors: Martin Mayer, Durbach (DE); Gerhard Welker, Muehlausen (DE); Claus Kollmannsperger, Reilingen (DE)

(73) Assignee: SAP-AG, Walldorf (DE)

(21) Appl. No.: 12/571,241

(22) Filed: Sep. 30, 2009

(51) Int. Cl. G06F 17/30

(52) U.S. Cl. 707/687; 707/E17.007

(57) ABSTRACT

A system for quickly identifying correlated data with a set of matching criteria in structured data. The data is presented as a user interface mechanism such as a slider that can be integrated into existing applications. The user can use the slider to identify the correlated data the user wishes to see, which is then output to the user through the application or a set of analytical tools.

### BACKGROUND

1. Field of the Invention

The Embodiments of the invention relate to a system for identifying and organizing changes or parameter matches in data structures. Specifically, embodiments of the invention relate to a system for traversing a data structure to identify sets of data that have changes or specific matching parameters and for presenting these data sets for selection through a user interface mechanism such as a slider.

2. Background

In the field of supply chain management and product lifecycle management, product development is managed through a series of interrelated data structures. One of these data structures is a bill of materials. A bill of materials can be organized as structured data that is specific to the entity that utilizes that data. For example, a design engineer may generate a structured bill of materials that is organized in a manner that is useful to design engineers. This organization of a product is from a hierarchal point of view. At a design level, the components and sub-components of the product are organized as assemblies and sub-assemblies. Similarly, the data structure of the bill of materials has a hierarchy that matches this with assembly and sub-assembly relationships between entries in the data structure.

In one example, a design bill of materials data structure for an airplane organizes the parts of the airplane into a hierarchy where the airplane as a whole product is at the highest level in the hierarchy and the sub-assemblies of the airplane are the fuselage, wings and engines are at the next lower level of the data structure hierarchy. Further sub-assemblies follow at lower points in the data structure hierarchy. The parts of the body, the parts of the wings and the parts of the engine are in this next level.

In addition, over time many of the components of the product are changed, upgraded or different versions are utilized. Tracking the differences in data structures over time within the same data structures can make it difficult for an individual to try and find specific information and to find all the correlated information. For example, if a user wants to know which fuselage sub-assembly parts were in use at the same time that a particular version of an engine was in use, then the user would have to traverse the data structure to find the engine to determine the version of the engine and look up its time frame then go back to the fuselage sub-assembly and find those parts that have the exact same time frame. This traversal and comparison is slow, time consuming and inefficient for the user.

### BRIEF DESCRIPTION OF THE DRAWINGS

Embodiments of the invention are illustrated by way of example and not by way of limitation and the figures of the accompanying drawings in which like references indicate similar elements. It should be noted that different references to “an” or “one” embodiment in this disclosure are not necessarily to the same embodiment, and such references mean at least “one.”

FIG. 1 is a diagram of one embodiment of the system for providing a data set selection mechanism.

FIG. 2 is a flowchart of one embodiment of a process for identifying a data set.

FIG. 3 is a diagram of one embodiment of an example application of the data set selection system.

### DETAILED DESCRIPTION

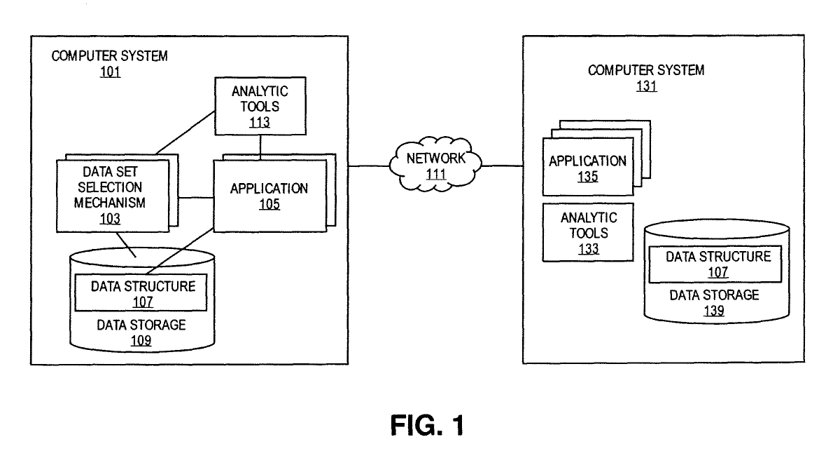

FIG. 1 is a diagram of one embodiment of a system for providing a data set selection mechanism. The system can be implemented in a computer system 101 or can be implemented over a distributed system. The distributed system includes the computer system 101, which is networked with other computer systems 131. The local computer system 101 and the remote computer system 131 can be desktop computers, handheld computers, work stations, servers, laptops and similar computing devices. These devices can be in communication over a network 111 such as a local area network (LAN), a wide area network (WAN), such as the Internet, or similar communication systems. The system can include any number of networked computers. For sake of clarity a system with two computers is described. However, one of ordinary skill in the art would understand that the structures, features and functions described are also applicable to systems with additional computers.

The computer system 101 can include a data set selection mechanism 103, analytical tools 113, a set of applications 105, a data structure storage unit 109 and similar components. In one embodiment, where the data set selection mechanism implementation is distributed, a remote computer system 131 can include a set of applications 135, analytical tools 133 and data structures 139 and similar components. A ‘set,’ as used herein refers to any whole positive number of items including one item.

A data set selection mechanism component 103 is a utility for providing a user interface element that enables the easy identification and selection of related information referred to herein as a data set or a data slice. This utility can be utilized by any type of application 105 that works with complex data structures 107. The data set selection mechanism 103 traverses the data structure 107 selected or provided by an application 105 to identify a set of data elements where a specified criteria is met. The data structure can be searched for changes to a data element or for data elements with specific values or value ranges. For example, in a data structure for a bill of materials, if one field of the data structure being traversed is a version field related to a part of a product and another parameter or field is time, then the data set selection mechanism may identify all changes over time to different versions of the part of the product (e.g., the dates that a different model of engine was introduced for an aircraft model).

The data set selection mechanism 103 creates a user interface for easily viewing the correlated data for the identified data elements. For example, a data set selection mechanism 103 can generate a slider bar with a defined set of positions corresponding to each of the state changes for the data structure over time. Any combination of two data elements of the data structure can be tied to a single slider bar whereas combinations of more than two can be mapped to multiple slider bars or similar user interface elements. The user interface generated by the data set selection mechanism 103 can be a stand-alone interface or integrated into an application 105.

Further, the data set selection mechanism 103 handles the input of a selection of a particular point. For example, the slider bar element can be use to select any particular point along the slider bar. In response to a selection, the data set selection mechanism retrieves and presents the correlated data graphically or as a data file or data stream to the associated application 105. This output can also be utilized by analytical tools 113 in conjunction with the application 105 or separately from the applications 105. Analytical tools 113 can be any type of program, code, plug-in or similar functions that process the output data for an application 105. The analytical tools 113 can perform any type of data analysis on an entire output or any subset of the data structure 107 presented by the data set selection mechanism 103.

In the distributed implementation, the applications 135 that are utilizing or calling the data set selection mechanism 103 can be remote from the computer system 101. These applications 135 can be on a computer system 131 communicating with the data set selection mechanism 103 over a network 111. Similarly, the analytical tools 133 and data structures 137 with which the data set selection mechanism 103 operates or communicates with can similarly be located on a remote computer system 131. Any number of computer systems can be networked together to provide these distributed services. Any combination of local and remote or distributed components can interface and operate with the data set selection mechanism 103.

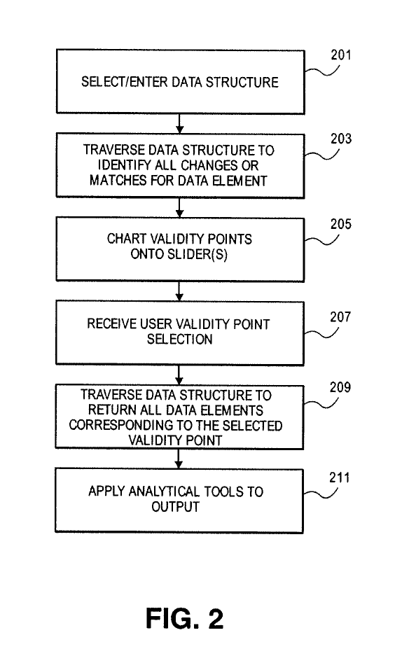

FIG. 2 is a flowchart of one embodiment of a process for identifying a data set. In one embodiment, the use of the data set selection mechanism can be initiated by the selection or entry of a particular data structure by an application or similar program (Block 201). A single data structure or in some embodiments multiple data structures can be analyzed using the data set selection mechanism. The data set selection mechanism traverses the data structure to identify all of the changes to data elements or all data elements matching specified criteria that are defined by the application or configuration (Block 203). These data elements can be fixed for a particular application or can be configurable by a user or application. Any combination and number of data elements can be specified. Data elements can refer to data entries or objects in a data structure, values of these data entries, identifiers or relationships amongst the data entries or objects or similar aspects of a data structure.

Each of the data element changes or matches is mapped or charted onto a user interface element (Block 205). The user interface element may be slider bar or similar user interface element. Each of the changing or matching data elements can be displayed or indicated on the user interface. For example, each of the valid positions for placing the slider on the slider bar may be illustrated as a notch or line on the slider bar. Each of these valid positions corresponds to a changing or matching data element.

The user can then interact with the slider bar or similar user interface element to select a particular validity point or corresponding data set (Block 207). Once the user has selected or confirmed a particular validity point in the user interface mechanism, the data set selection mechanism traverses the data structure again to retrieve all of the data elements that are correlated to the data element that was selected (Block 209). For example, if the data structure is a bill of materials for the design level of an aircraft, then the data slider can be a mapping of the state changes or part changes for the aircraft over time. Each slider position or validity point indicates a date where a change occurred. Selecting the validity point or any point after it, but before the next validity point can be configured to pull all of the data element values that are associated with that date. In this case, all the parts of the aircraft that were in use on the selected date are retrieved. The resulting data is then displayed to the user or passed on to the calling application.

In another embodiment, the gathered data is passed onto an analytical tool that further analyzes the data. For example, the analytical tool can be a filter, visualization tool (e.g., a charting tool), trend analyzer or similar analytical tool. For example, an analytical tool can filter the parts output by the data set selection mechanism to remove all parts that are original parts before being output to the user or calling application (Block 211). The analytical tool can be integrated into the application, can be a stand-alone tool or can be a library function or similar program.

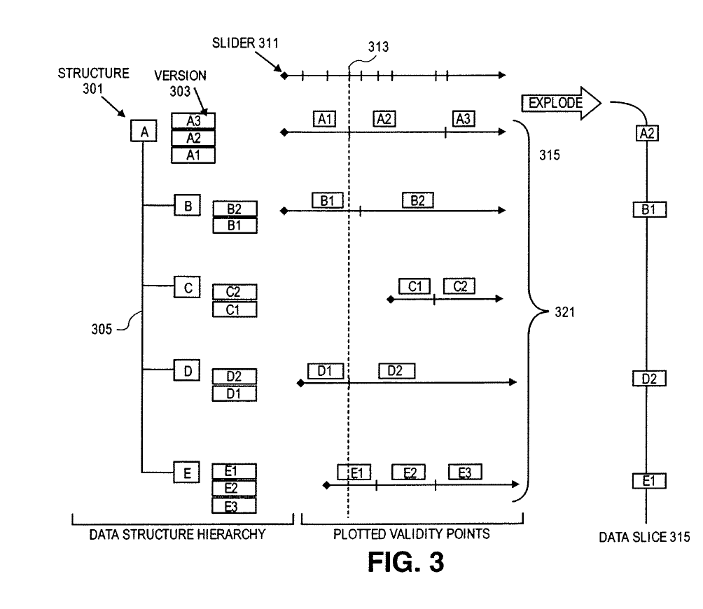

FIG. 3 is a diagram of one embodiment of an example application of the data set selection system. In the example, the data structure 301 has a first data element A, which is the highest point of the hierarchy of the data structure and a number of subordinate data elements B, C, D and E 305. Each of the data elements has a set of version numbers 303. Each of the version numbers has a validity date range 321 for the life time of the product over which they are valid. The slider 311 charts each of the validity dates corresponding to one of these version changes.

The user can select a specific point, for example, point 313 to obtain a data set of all of the versions that were in use on that date. The data set selection mechanism then extrapolates that data as a separate data structure or data slice 315, which is output to an application or displayed for a user. This is one example application of the data set selection mechanism. The use of the data set selection mechanism with a data structure based on time and part versions is provided by way of example. However, other data elements can be processed in the same manner. For example, a data structure containing information about the size and color of a product could be plotted by the data set selection mechanism by identifying a particular color (e.g., blue) and finding each of the sizes of the product that are available in blue. The slider would then have validity points that identify each size where a color of blue exists. Selection of the validity point would result in retrieval of other data related to the product having the blue color and at the selected size. One skilled in the art would understand that the principles, structures and features described in regard to these example applications can be applied to any combination of criteria and any number of criteria and for any data structure.

In one embodiment, the data set selection mechanism can be implemented as a set of hardware devices. In another embodiment, the system components are implemented in software (for example microcode, assembly language or higher level languages). These software implementations can be stored on a computer-readable medium. A “computer-readable” medium can include any medium that can store information. Examples of the computer-readable medium include a read only memory (ROM), a floppy diskette, a CD Rom, a DVD, a flash memory, a hard drive, an optical disc or similar medium.

In the foregoing specification, the invention has been described with references to specific embodiments. It will, however, be evident that various modifications and changes can be made thereto without departing from the broader spirit and scope that is set forth in the appended claims. The specification and drawings are accordingly to be regarded in illustrative rather than a restrictive sense.

What is claimed is:

1. A method comprising:
receiving a selection of a data structure;
traversing the data structure to identify a plurality of data elements having matching criteria as a plurality of validity points; and
generating a user interface mechanism to enable a selection of one of the plurality of validity points.

2. The method of claim 1, further comprising:
receiving a selection of a validity point; and
retrieving a plurality of data elements from the data structure corresponding to the selection.

3. The method of claim 2, further comprising:
traversing the data structure to identify at least one data element corresponding to the selection.

4. The method of claim 2, further comprising:
outputting the plurality of data elements; and
executing an analytical tool on the output.

5. The method of claim 1, wherein the user interface mechanism is a slider with a plurality of positions corresponding to each of the plurality of validity points.

6. The method of claim 2, wherein the matching criteria include at least two criteria.

7. The method of claim 6, further comprising:
generating another user interface mechanism in response to at least three criteria being matched.

8. The method of claim 7, further comprising:
charting the plurality of validity points onto the slider.

9. A computer-readable medium, having instructions stored therein, which when executed cause a computer to perform a set of operations comprising:
receiving a selection of a data structure and a first criteria;
traversing the data structure to identify a plurality of data elements that correspond to the first criteria;
generating an interactive display of an aggregate of the data elements as a user interface mechanism to allow selection of plurality of data elements with a matching value for the first criteria.

10. The computer-readable medium of claim 9, having further instructions stored therein, which when executed cause a computer to perform a set of operations comprising:
receiving a selection of a first validity point; and
retrieving a plurality of data elements from the data structure corresponding to the selection.

11. The computer-readable medium of claim 10, having further instructions stored therein, which when executed cause a computer to perform a set of operations comprising:
traversing the data structure to identify at least one data element corresponding to the selection.

12. The computer-readable medium of claim 10, having further instructions stored therein, which when executed cause a computer to perform a set of operations comprising:
outputting the plurality of data elements; and
executing an analytical tool on the output.

13. The computer-readable medium of claim 9, wherein the user interface mechanism is a slider with a plurality of positions corresponding to each value of the first criteria with a matching data element.

14. The computer-readable medium of claim 10, wherein the first criteria is a change of state of a product.

15. The computer-readable medium of claim 14, having further instructions stored therein, which when executed cause a computer to perform a set of operations comprising:
receiving a selection of a second criteria; and
generating a plurality of interactive user interface elements corresponding to the second criteria.

16. The computer-readable medium of claim 15, having further instructions stored therein, which when executed cause a computer to perform a set of operations comprising:
traversing the data structure to identify a plurality of data elements that correspond to the second criteria.

17. A system comprising:
a data storage device to store a data structure;
a data set selection mechanism in communication with the data storage device to generate a user interface mechanism to enable selection of a plurality of data elements based on a corresponding value of the plurality of data elements.

18. The system of claim 17, further comprising:
an analytic tool component to communicate with the data set selection mechanism to process the output of the data set selection mechanism.

19. The system of claim 15, wherein the data set selection mechanism is called by an application to generate the user interface mechanism for the application.

20. The system of claim 15, wherein the data set selection mechanism identifies the plurality of data elements by traversal of the data structure to find data elements that correspond to a criteria.
